(19) United States
(12) Patent Application Publication
(10) Pub. No.: US 2009/0201151 A1
(43) Pub. Date: Aug. 13, 2009

(54) LOCKED OR UNLOCKED STATUS KEY INDICATOR SYSTEM

(75) Inventors: Yosef De Levie, Tel Aviv (IL); Alon Goldstein, Hertzlia (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: Microdel Ltd., Ramat Gan (IL)

(21) Appl. No.: 12/304,294

(22) PCT Filed: Jun. 14, 2007
(86) PCT No.: PCT/IL07/00722

§ 371 Date: Dec. 11, 2008

Related U.S. Application Data
(60) Provisional application No. 60/805,360, filed on Jun. 21, 2006.

(51) Int. Cl. G08B 21/00

(52) U.S. Cl. 340/540

(57) ABSTRACT

An electronic device that can be mounted onto almost any type of key, for indicating the lock/unlocked status of the lock operable by the key. The electronic device includes a processing unit that when rotational torque force being applied on the key, the processing unit identifies depressed contact sensors, and determines whether the lock was last rotated clockwise (typically locking direction) or counterclockwise (typically unlocking direction). Data representing the rotation direction is stored in the memory. When a designated switch is operated, the electronic device activates an indication that indicates whether the lock is in a lock state or in an unlocked state, according to the data stored in the memory.

### FIELD OF THE INVENTION

The present invention relates to electronic devices for indicating a key lock/unlock status, and more particularly the present invention relates to an electronic device that can be mounted onto almost any type of key, and that detects and identifies the direction of a rotational torque force being applied to a key, to be either in a counterclockwise direction (typically unlocking) or in a clockwise direction (typically locking).

### BACKGROUND AND RELATED PRIOR ART

Often people unconsciously insert a key into a door lock, turn the key to the locking position and remove the key from the lock. Later the person cannot remember if the door was locked lock or not. For the peace of mind, a person will return to the door to check if the door is locked lock or not.

There are a number of prior art systems that electronically check whether a door was last locked or when the door was locked. Some prior art systems are based on the direction of the turning of the key. Other prior art systems include electronic sensors inserted into the lock or attached to the door frame in the vicinity of the lock.

Some of the prior art systems do not accommodate the fact that more than one key may be used to lock or unlock a door. Other prior art systems require the replacement of existing locks and/or keys. For example, U.S. Pat. No. 6,886,382, given to Felix Harold, provides a toggle bar which is pivotally mounted or disposed on a key stem. The toggle bar operates in conjunction with a lock cam and an unlock cam mounted on the face of the complementary lock set. When the operator turns the key in one direction, the lock cam motivates the toggle bar thereby shifting its position. An indicator disposed in the key body displaying a lock condition and an unlock condition.

Thus there is a need for and it would be advantageous to have a universal device that can be mounted onto almost any type of key, can indicate the lock/unlock status of a lock, and can provide the indication regardless of the distance from the lock and regardless of when and/or with which key a door was last locked or opened.

### BRIEF SUMMARY OF THE INVENTION

It is the intention of the present invention to provide an electronic device that can be mounted onto almost any type of key, indicate the lock/unlocked status of the lock operable by a key, and provide the indication regardless of the distance from the lock and regardless of when and/or with which key a lock was last opened or locked. The electronic device can indicate whether the entrance door was left locked or unlocked when leaving the premises at any distance and any time.

The electronic device of the present invention is designed to be mounted onto an existing key, and to indicate to the carrier of the key whether the lock operable by the key was last opened or locked. There is no need to adhere magnets, sensors or any other device or system to the lock, to the door or to the door frame. The system is low cost, easy to manufacture and fits onto most existing keys.

According to the teaching of the present invention there is provided an electronic device, mountable onto a key head, for indicating whether the lock operable by the key is locked or unlocked, the electronic device including:

a) a housing including two base plates;

b) elastic supporters;

c) contact sensors;

d) processing unit and memory;

e) one or more indicators; and

f) a power source,

whereas upon the turning of the key inside a lock keyhole, having the electronic device of the present invention mounted on the head part of the key, rotational torque is applied onto one side of one base plate and onto the opposite side of the opposing base plate. The rotational torque compresses the elastic supporters and a relative rotational motion is introduced between the key and the generally parallel base plates, thereby one pair of contact sensors is depressed, closing an electrical circuit signaling the detection of the rotational torque force being applied to the key. The directional data is stored by the processing unit in a memory and upon request the directional data is used to indicate to the user the latest lock/unlock status of the lock operable by the key.

In embodiments of the present invention, the electronic device provides a locked/unlocked indicator that gives a visual signal when the door is considered to be locked and/or unlocked.

In embodiments of the present invention, the electronic device is optionally used as a torch to light up the keyhole.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1A is a partial sectional front view schematic illustration of an electronic device for indication a lock/unlock status of a lock, according to embodiments of the present invention, mounted on a standard key;

FIG. 1B is a side view illustration showing cross-section A-A of the electronic device, mounted on a standard key, shown in FIG. 1A;

FIG. 1C is a side view illustration showing cross-section A-A of the electronic device, mounted on a standard key, shown in FIG. 1A, when the key is being turned by a rotational force F_{R};

FIG. 1D is a side view illustration showing cross-section A-A of the electronic device, mounted on a standard key, shown in FIG. 1A, when the key is being pushed by an unwarranted random linear force F_{L}.

FIG. 2 is a schematic block diagram of the electronic system of the electronic device shown in FIG. 1A;

FIG. 3 shows an example of an electrical design of the electronic device shown in FIG. 1A; and

FIG. 4 is a side view of a sectional illustration of an electronic device, according to embodiments of the present invention, mounted on a standard key.

### DETAILED DESCRIPTION OF THE INVENTION

Before explaining embodiments of the invention in detail, it is to be understood that the invention is not limited in its application to the details of construction and the arrangement of the components set forth in the host description or illustrated in the drawings.

Unless otherwise defined, all technical and scientific terms used herein have the same meaning as commonly understood by one of ordinary skill in the art of the invention belongs. The methods and examples provided herein are illustrative only and not intended to be limiting.

The present invention provides an electronic device that can be mounted onto almost any type of key, for indicating the lock/unlocked status of the lock operable by the key. The electronic device of the present invention provides the indication regardless of the distance from the lock and regardless of when and/or with which key a lock was last opened or locked. The electronic device can indicate whether the entrance door was left locked or unlocked when leaving the premises at any distance and any time.

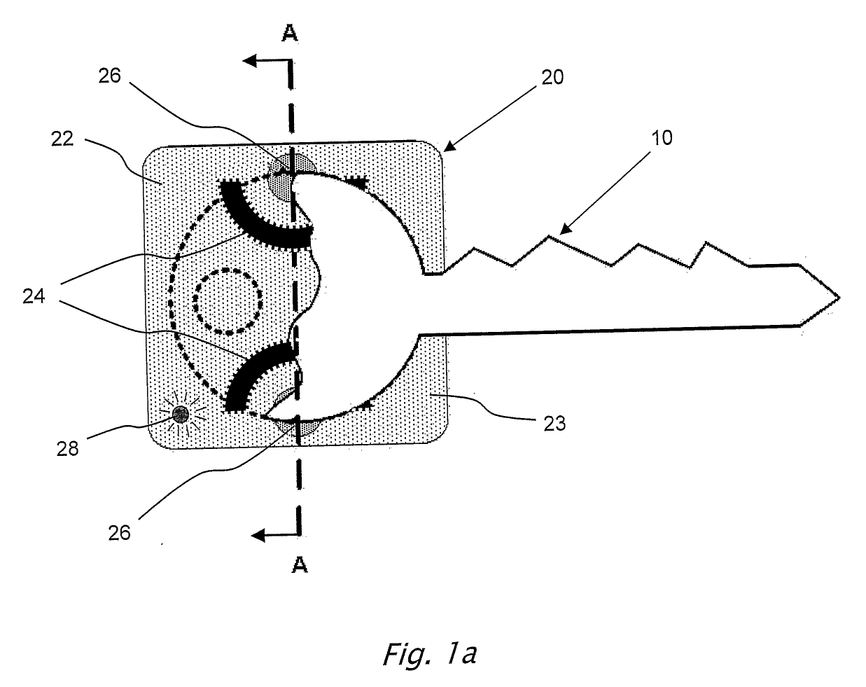

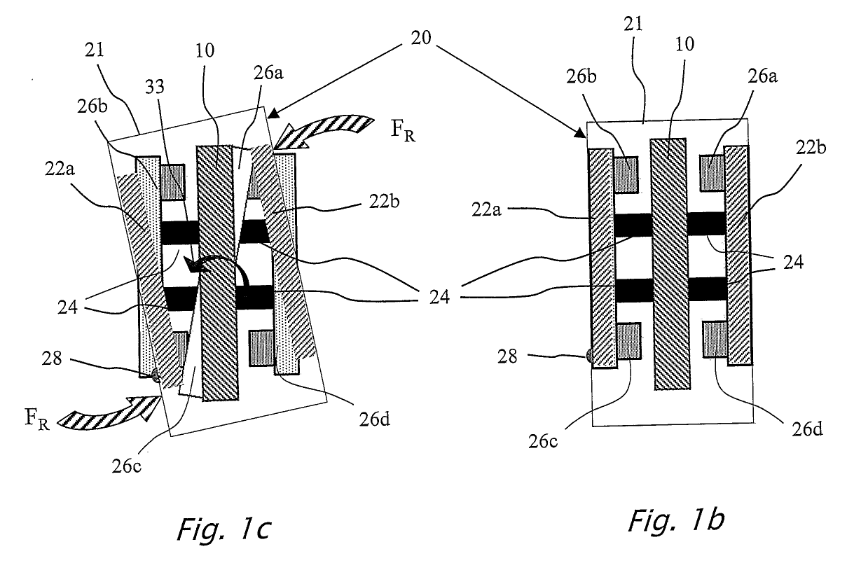

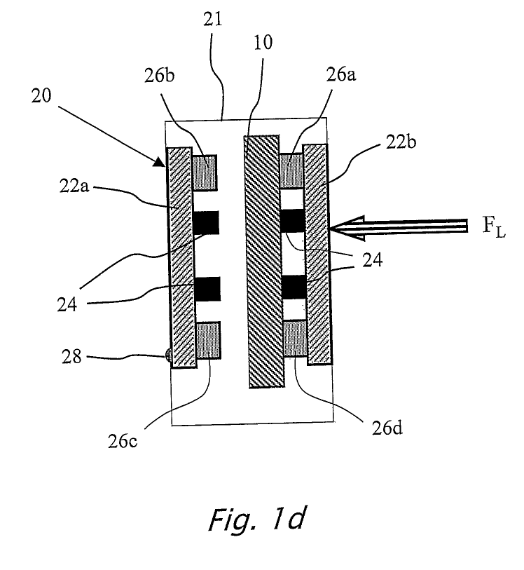

Referring is now to the drawings, FIG. 1A is a partial sectional front view schematic illustration of the electronic device 20 for indication a lock/unlock status of a lock, according to embodiments of the present invention, mounted on a standard key 10. Reference is also made to FIG. 1B, which is a side view illustration showing cross-section A-A of electronic device 20, mounted on a standard key 10, shown in FIG. 1A. Electronic device 20 includes:

a) a housing 21 (not showing in FIG. 1A) including base plates 22;

b) elastic supporters 24;

c) contact sensors 26;

d) processing unit and memory;

e) one or more indicators 28; and

f) a power source.

The present invention includes an electronic sub-system capable of recognizing the key rotational direction in a lock keyhole, by detecting and identifying the direction of the rotational torque force applied to the key. Reference is now also made to FIG. 1C, which is a side view illustration showing cross-section A-A of electronic device 20, mounted on a standard key 10, shown in FIG. 1A, when key 10 is being turned, for example, in direction 33 (typically unlocking). Upon the turning of key 10 inside the lock keyhole, having electronic device 20 mounted on the head part of key 10, rotational force F_{R} is applied by the user onto one side of base plate 22a and onto the opposite side of base plate 22b. In the example shown in FIG. 1C, rotational force F_{R} is applied to the upper part of plate base 22b and to the lower part of base plate 22a. The rotational force F_{R} applied by the user creates a torque force, which compresses elastic supporters 24. A relative rotational motion is formed between the key and generally parallel base plates 22, thereby one pair of contact sensors 26a and 26c is depressed, closing an electrical circuit signaling a detection of an unlocking rotational torque force F_{R} being applied to key 10. In the case where a key 10, having an electronic device 20 mounted, is turned in the opposite direction to direction 33, i.e. in a typical locking direction, the second pair of contact sensors 26b and 26d will be depressed, closing an electrical circuit signaling a detection of a locking rotational torque force F_{R} being applied to key 10.

FIG. 1D is a side view illustration showing cross-section A-A of electronic device 20, mounted on a standard key 10, shown in FIG. 1A, when key 10 is being pushed by an unwarranted random linear force F_{L}. In the example shown in FIG. 1D, a random linear force F_{R} is applied to the central region of plate base 22b, for example, by the pressure of the pocket in which key 10 is stored. Linear force F_{R} compresses elastic supporters 24 and A relative motion is formed between the key and generally parallel base plates 22, thereby one pair of contact sensors 26a and 26d is depressed. However, depressed sensors 26a and 26d do not generate any signal indicating a change the rotational torque force being applied to key 10.

Elastic supporters 24 can be implemented as mechanical springs, or by elastic materials, the elastic materials selected from a group of materials including rubber, rubber compositions, elastic plastics, elastic polymers, elastic polyurethane, etc. The mechanical springs can be part of contact sensors 26.

Indicator 28 includes two distinguishable modes, wherein a first mode indicates that the lock operable by key 10 is closed, and a second mode indicates that the lock is open.

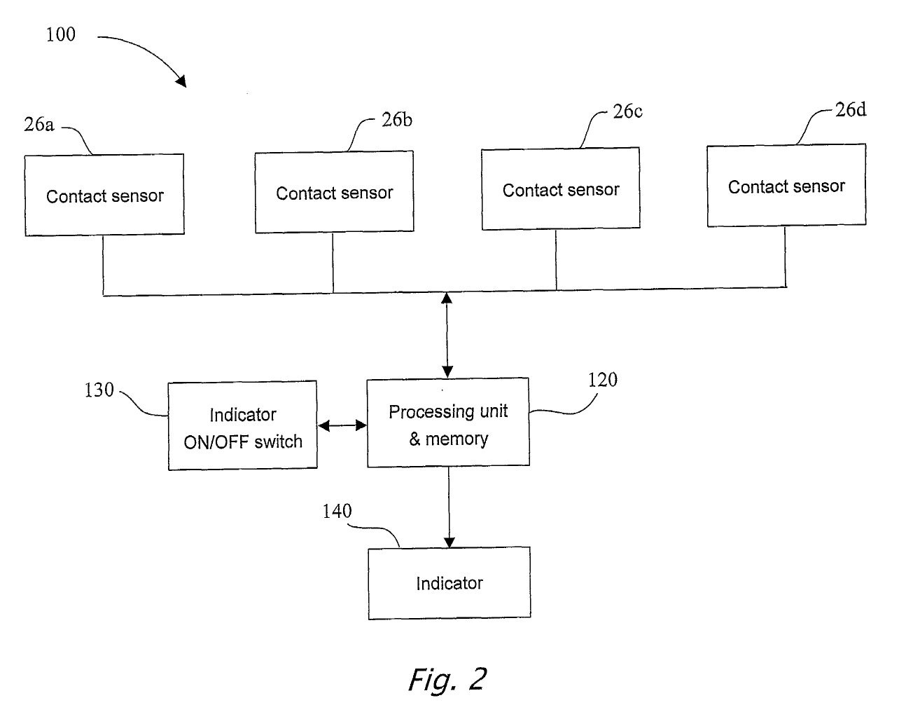

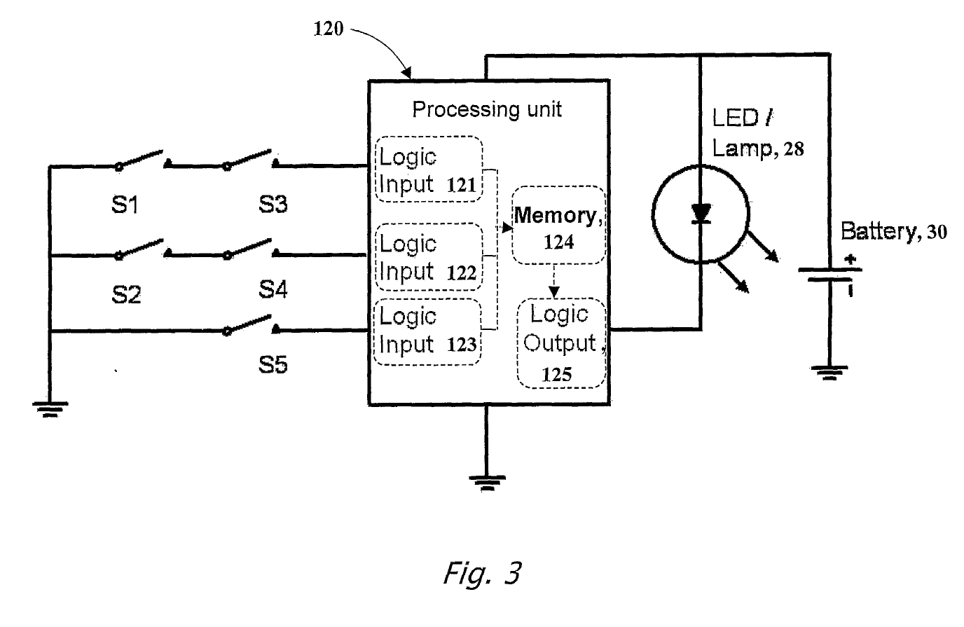

Reference is now also made to FIG. 2, which is a schematic block diagram 100 of the electronic system of electronic device 20 shown in FIG. 1A, and to FIG. 3 which shows an example of an electrical scheme utilized by electronic device 20 shown in FIG. 1A. Processing unit 120 identifies the depressed contact sensors 26, analyzes the contact sequence and timing, and determines whether the lock was rotated clockwise or counterclockwise. Data representing the rotation direction is preferably stored in the memory of processing unit 120.

Upon termination of the rotational torque force F_{R} being applied to key 10, elastic supporters 24 force the position of key 10, relative to base plates 22, back to the generally middle resting position between the two base plates 22, as shown in FIG. 1B, thereby bringing all contact sensors 26 to a non-depressed position.

Reference is now also made to FIG. 3, which shows an example of an electrical design of electronic device 20, shown in FIG. 1A. Switch S1 is the electrical equivalent to contact sensor 26a, switch S2 is the electrical equivalent to contact sensor 26b, switch S3 is the electrical equivalent to contact sensor 26c and switch S4 is the electrical equivalent to contact sensor 26d. Referring back to the example shown in FIG. 1C, when the pair of contact sensors 26a and 26c is depressed, switches S1 and S3 are closed and input logic unit 121 identifies rotational torque force F_{R}, applied to key 10, to be in a counterclockwise direction 33 (typically unlocking). If switches S2 and S4 are closed, input logic unit 122 identifies rotational torque force F_{R}, applied to key 10, to be in a clockwise direction (typically locking).

Referring back to the example shown in FIG. 1D, when the pair of contact sensors 26a and 26d is depressed, switches S1 and S4 are closed but input logic units 121 & 122 do not identify a rotational torque force F_{R}, applied to key 10, as no electrical circuit is being closed.

In embodiments of the present invention, when a switch S5, which is the electrical equivalent to ON/OFF switch 130, is closed, input logic unit 123 operates an output logic unit 125, which in turn uses the directional data saved in memory 124 to activate a proper lock status indicator. When switch S5 activated, processing unit 120 turns on the indication that show the state of the lock. The indication is provided by an indicator selected from a group of indicators including a led light 28 (on/off, colored, flashing, etc.), an LCD display, a mechanical indicator such as a moving pin, or any other type of indicators known in the art.

It should be noted that there is no need for electronic device 20 to be mounted on key 10 in order to indicate the lock/unlock status of key 10, but only to be powered on. It should be noted that S5 is an optional switch and is required only with some of the types of indicators 28. For example, if indicator 28 is an LCD display, switch 130 (S5) is not needed, but if indicator 28 is an LED light switch 130 (S5) is most likely needed. It should be further noted that in some cases, if the indication is continuously shown, for example in the case where indicator 28 is a mechanical flag with two optional positions indicating lock/unlock, memory 124 is also not needed.

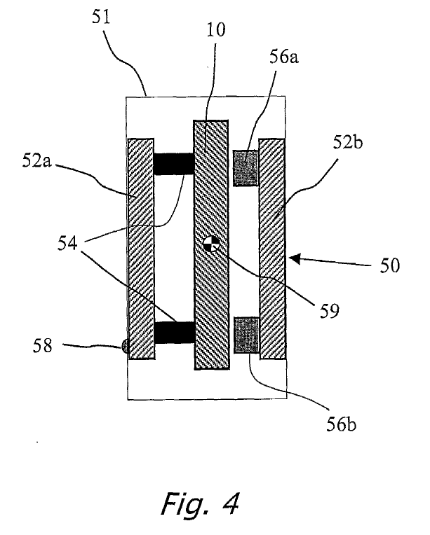

It should also be noted that the use of four contact sensors 26 is given by way of example only. In other embodiments of the present invention, any number of contact sensors 26 can be used in either direction. In another embodiment of the present invention, only contact sensor 26a (typically for unlocking detection) and contact sensor 26b (typically for locking detection) are used. In yet another embodiment of the present invention, only contact sensor 26c (typically for unlocking detection) and contact sensor 26d (typically for locking detection) are used. Referring back to the example shown in FIG. 3, switches S3 and S4 can be discarded, thereby using only switches S1 and S2 to detect and identify rotational torque force F_{R} being applied to key 10. Reference is now made to FIG. 4, which is a side view of a sectional illustration of an electronic device 50, according to embodiments of the present invention, mounted on a standard key 10. In the embodiment shown in FIG. 4, only two contact sensors 56 are used. Electronic device 50 is operated similarly to electronic device 20: contact sensor 56a is depressed when rotational torque force F_{R} is applied to key 10 in counterclockwise direction (typically unlocking), and contact sensor 56b is depressed when rotational torque force F_{R} is applied to key 10 in clockwise direction (typically locking). Processing unit 120 determines the rotational direction and stores the data representing the rotation direction in memory 124.

Electronic device 50 is more sensitive than electronic device 20 to random forces F_{L} pressing onto housing 51 when key 10 is not operating a keyhole. Unwarranted random forces F_{L} pressing onto housing 51 may depress a contact sensor 56, thereby causing a false directional indication to be stored in memory 124 of electronic device 50. To prevent unwarranted random operation of electronic device 50, a mechanism is added to electronic device 50, preferably to housing 51, the mechanism allows the depression of contacts 56, only when rotational torque force F_{R} is applied to key 10 about axis 59. The probability for unwarranted false operation of electronic device 20 is substantially smaller but still exists. The measures taken to allow depression of contacts 56, only when rotational torque force F_{R} is applied to key 10, can also be implemented in all embodiments of electronic device 20.

Electronic device 20 can be operated by a battery 30 or any other type of electrical power source.

In embodiments of the present invention, electronic device 20 is optionally used as a torch, for example to light up the keyhole.

Although this invention has been described with a certain degree of particularity, it is to be understood that the present disclosure has been made by way of example only and that numerous changes in the detailed construction and the combination and arrangement of parts may be resorted to, without departing from the spirit and scope of the invention as hereinafter claimed.

1. An electronic device for indicating a lock or unlock status of a lock, the device comprising:
a) a housing comprising a back and front base plates;
b) elastic supporters;
c) contact sensors;
d) a processing unit;
e) one or more status indicators; and
f) a power source.

2. The device of claim 1, wherein when the electronic device is mounted on a key and said key is turned inside a lock keyhole by a user applying a rotational torque force to said key, said elastic supporter are depressed and said base plates operatively press corresponding said contact sensors, thereby sending a signal to said processing unit, thereby said processing unit detects and identifies said rotational torque force direction, being applied to said key, and thereby determining whether said rotational torque force is in a clockwise direction (typically locking) or counterclockwise direction (typically unlocking).

3. The system of claim 1, further comprising:
g) an indication switch.

4. The device of claim 1, wherein said processing unit stores the data representing said determined rotational torque force direction, in said memory.

5. The device of claim 1, wherein said indication switch is turned on, said processing unit activates the said at least one indicator according to said determined rotational torque force direction stored in said memory.

6. The system of claim 1, wherein said at least one indicator is selected from a group of indicators including one or more LED lights, and LCD display, an audible device such as a speaker, a mechanical indicator.

7. The device of claim 6, wherein said indicator comprises two or more distinguishable modes, wherein a first mode indicates that the lock operable by said key is closed, and a second mode indicates that said lock is open.

8. The device of claim 1, wherein said contact sensors comprise one or more contact sensors for locking sensing and one or more contact sensors for unlocking sensing.

9. The device of claim 1, wherein said elastic supporters can be embodied as mechanical springs, or elastic materials, wherein said elastic materials are selected from a group of materials including rubber, rubber compositions, elastic plastics, elastic polymers, elastic polyurethane, etc.

10. The device of claim 1, wherein said elastic supporters form of one or more pieces.

11. The device of claim 6, wherein said LED light indicator is used as a torch.

12. The device of claim 1, wherein said power source is a battery.

13. The device of claim 2, wherein upon termination of said rotational torque force being applied to said key, said elastic supporters force the position of said key, relative to said base plates, back to the generally middle resting position between said back base plates and said front base plates, thereby all of said contact sensors are in a non-depressed position.
